(19) United States
(12) Patent Application Publication
(10) Pub. No.: US 2025/0232667 A1
(43) Pub. Date: Jul. 17, 2025

(54) SYSTEMS AND METHODS FOR VEHICLE-CENTERED COMMUNITY IMPROVEMENT

(71) Applicant: Honda Motor Co., Ltd., Tokyo (JP)

(72) Inventors: Xue BAI, Redondo Beach, CA (US); Tomoaki Yajikawa, Redondo Beach, CA (US)

(21) Appl. No.: 18/619,672

(22) Filed: Mar. 28, 2024

Related U.S. Application Data
(60) Provisional application No. 63/621,519, filed on Jan. 16, 2024.

(51) Int. Cl. G08G 1/01

(52) U.S. Cl. CPC G08G 1/0116; G08G 1/0133

(57) ABSTRACT

A roadway issue detecting and reporting system is provided. The system includes a plurality of sensors including a global positioning system (GPS) sensor and a roadway observing sensor. The system also includes a first controller communicatively coupled to the plurality of sensors. The first controller is programmed to receive roadway data and GPS location data from the plurality of sensors, detect a roadway issue based on the roadway data and a corresponding location based on the GPS location data, and generate roadway issue data including roadway issue classification data and the GPS location data associated with the roadway issue. The first controller is also programmed to transmit the roadway issue data to a remote server, receive confirmation data from the remote server, and present the confirmation data to a user.

### CROSS-REFERENCE TO RELATED APPLICATIONS

This application claims the benefit of priority to U.S. Provisional Patent Application Ser. No. 63/621,519, filed Jan. 16, 2024, and entitled “SYSTEMS AND METHODS FOR VEHICLE-CENTERED COMMUNITY IMPROVEMENT”, the contents and disclosures of which are hereby incorporated in their entirety.

### FIELD OF THE INVENTION

The present disclosure relates generally to automatic road condition monitoring systems, and more specifically, to systems and methods that incentivize roadway-betterment actions and increase the engagement a road user feels toward the roadway being used.

### BACKGROUND

Modern roadways can include stationary or temporary hazards, such potholes, debris in the roadway, damaged and/or illegible street signs, unlit streetlights, downed power lines, or damaged roadway barriers. Police and other municipal workers may be tasked with inspecting the streets of their municipality, however, they are not able to inspect all roadways in a municipality with any regularity. For example, potholes not only have a chance of damaging a vehicle driving over the pothole, but also decrease the driver's and passenger's enjoyment of the ride. Furthermore, damaged street signs and roadway barriers, along with unlit streetlights, do not provide location information and/or otherwise assist a driver as was originally intended when the signs and lights were installed.

Accordingly, it would be desirable to have methods and systems that facilitate automatic identification of roadway issues to both initiate a repair and to provide a user with information that leads to a sense of engagement and/or ownership with respect to a roadway or geographical area.

### BRIEF SUMMARY

In one aspect, a roadway issue detecting and reporting system is provided. The system includes a plurality of sensors including a global positioning system (GPS) sensor and a roadway observing sensor. The system also includes a first controller communicatively coupled to the plurality of sensors. The first controller is programmed to receive roadway data and GPS location data from the plurality of sensors, detect a roadway issue based on the roadway data and a corresponding location based on the GPS location data, and generate roadway issue data including roadway issue classification data and the GPS location data associated with the roadway issue. The first controller is also programmed to transmit the roadway issue data to a remote server, receive confirmation data from the remote server, and present the confirmation data to a user.

In another aspect, a vehicle is provided. The vehicle includes a plurality of sensors including a global positioning system (GPS) sensor and a roadway observing sensor, an input/output device, and a first vehicle controller communicatively coupled to the plurality of sensors and the input/output device. The first vehicle controller is configured to receive roadway data and GPS location data from the plurality of sensors, detect a roadway issue based on the roadway data and a corresponding location based on the GPS location data, and generate roadway issue data including roadway issue classification data and the GPS location data associated with the roadway issue. The first vehicle controller is also configured to transmit the roadway issue data to a remote server, receive confirmation data from the remote server, and transmit the confirmation data to the input/output device.

In yet another aspect, a roadway issue reporting system is provided. The system includes at least one memory device, and a server communicatively coupled to the at least one memory device and comprising at least one processor. The server is configured to receive roadway issue data from a vehicle, wherein the roadway issue data includes roadway issue classification data and GPS location data corresponding to a location of the roadway issue, determine a proper roadway related entity to contact, and transmit a repair request to the proper roadway related entity. The system is also configured to receive confirmation data from the proper roadway related entity, and store the confirmation data as user account data.

The systems and vehicle may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed herein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a schematic diagram of an exemplary embodiment of a vehicle.

FIG. 2 is an overview diagram of an exemplary embodiment of a process of detecting a roadway issue using a vehicle, for example, the vehicle shown in FIG. 1.

FIG. 3 is a block diagram of an exemplary embodiment of a roadway issue detecting system including a vehicle, for example, the vehicle shown in FIG. 1.

FIG. 4 is a timing diagram for the process of detecting and reporting a roadway issue, for example, the process shown in FIG. 2.

FIG. 5 is a flow chart of an exemplary computer-implemented process of detecting and reporting roadway issues using the system shown in FIG. 3.

FIG. 6 is a simplified block diagram of an exemplary computer system for implementing the processes shown in FIGS. 2-5.

FIG. 7 is a block diagram of an exemplary configuration of a user computer device, in accordance with at least one embodiment of the present disclosure.

FIG. 8 is a block diagram of an exemplary configuration of a server computer device, in accordance with at least one embodiment of the present disclosure.

FIG. 9 is an exemplary embodiment of a first screenshot of one example of a user interface that may be displayed as part of a roadway issue detecting system, for example, the roadway issue detecting system shown in FIG. 3.

FIG. 10 is an exemplary embodiment of a second screenshot of one example of a user interface that may be displayed as part of a roadway issue detecting system, for example, the roadway issue detecting system shown in FIG. 3.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present disclosure generally relates to automatic road condition monitoring systems, and more specifically, to a system that uses data from the automatic road condition monitoring systems, determines if the data includes information to report to a roadway related entity, determines the proper roadway related entity to report the information to, transmits the information, receives a confirmation from the proper roadway related entity, and reports the confirmation to the operator of the vehicle.

The systems and methods described herein allow properly equipped vehicles to automatically detect roadway issues and provide information to the roadway related entity responsible for care and maintenance of that roadway at that location. The systems and methods described herein also provide rewards and/or declarations of appreciation from the roadway related entity to the driver/owner of the vehicle that detected and reported the roadway issue. Such rewards/declarations may provide the recipient with a sense of engagement or ownership over the roadways upon which they were driving, and potentially, a broader sense of engagement or ownership over all roadways upon which they drive. This engagement may lead to overall community improvement.

There are known examples where people who feel engagement or responsibility for a geographic area treat that area with more respect. Examples include U.S. National Parks. The U.S. National Parks are typically cleaner and better maintained than areas outside of the National Parks. It is believed that the reason for this is not because of paid government employees keeping the parks beautiful, but rather, is because visitors to the National Parks have a feeling of shared ownership and responsibility over maintaining the beauty of the National Parks by cleaning up after themselves as well as being careful not to damage anything within the park.

Another example is that some drivers drive differently in different geographic areas. For example, a driver may consistently drive at or slower than the speed limit, as well as drive with a high level of courtesy to the other drivers on the road, when they are driving within the neighborhood where they live. In contrast, that same driver may consistently drive at speeds over the speed limit when on a highway further away from their home, and may also complain or be quick to anger, or otherwise drive with limited courtesy exhibited toward other drivers. It is believed that these drivers have a feeling of responsibility or ownership, a sense of community pride, for the neighborhood where they live. These feelings of engagement for that area lead to safer and more courteous driving. And in contrast, the lack of engagement, responsibility, or ownership felt for the highways may lead to less-courteous decisions being made.

Municipalities may have phone numbers or online forms accessible to the public for reporting roadway issues and/or requesting repairs. However, a majority of drivers on a roadway do not take the time or make the effort to search for the proper phone number/website address to contact to report an issue. This decision may be driven by driver apathy. Many drivers see that they are surrounded by other drivers and feel it is not their responsibility to report a roadway issue. This decision also is likely based on the driver not knowing what entity to even search for to find the proper phone number/website address. For example, even if the driver generally knows what city the roadway issue is present in, the driver does not likely know whether the city, a county, a township, and/or other municipality is responsible for repairing issues with that specific roadway at that specific location.

The present embodiments may relate to, inter alia, systems and methods for automatically detecting and reporting roadway issues, as well as providing feedback to the vehicle owner/driver that increases a feeling of engagement/responsibility for an increased number of roadways/areas. In an exemplary embodiment, the process is automatically performed by a roadway issue detecting system that includes components within a vehicle in communication with a remote server.

In the exemplary embodiment, the vehicle includes a plurality of sensors that allow the vehicle to observe its surroundings in real-time. The sensors can include, but are not limited to, radar, LIDAR, proximity sensors, ultrasonic sensors, electromagnetic sensors, wide RADAR, long distance RADAR, Global Positioning System (GPS), video devices, imaging devices, cameras, audio recorders, inertial measurement unit (IMU), and computer vision. A vehicle controller receives information from the sensors. Based on the information from the sensors, the vehicle controller detects roadway issues. The vehicle controller collects GPS location data corresponding to the location of the detected roadway issue, transmits data corresponding to the roadway issue and GPS location to a remote server, receives confirmation data from the remote server, and presents the confirmation data to the driver. In alternative embodiments, the roadway issue and detecting process may include an option for the driver to confirm at least one of the roadway issue and the GPS location, and/or manually provide additional information before the data corresponding to the roadway issue and GPS location is transmitted to the remote server.

At least one of the technical problems addressed by this system may include: (i) increased reporting of roadway issues; (ii) acknowledging receipt of the roadway issue report; (iii) increased respect/engagement over a larger number of roadways; (iv) improved physical condition of an increased number of roadways; and (v) improved safety of the roadways.

The methods and systems described herein may be implemented using computer programming or engineering techniques including computer software, firmware, hardware, or any combination or subset thereof, wherein the technical effects may be achieved by performing at least one of the following steps: a) receive user identification data; b) receive a plurality of information from the plurality of sensors; c) detect a roadway issue and GPS location of the roadway issue based on the plurality of information from the plurality of sensors; d) prompt the driver to verify or acknowledge the data transmission; e) transmit data corresponding to the roadway issue and GPS location to the remote server; f) determine a proper roadway related entity to contact; g) transmit a repair request to the proper roadway related entity; h) receive confirmation data (e.g., data related to a repair schedule, status of the repair, or appreciation/acknowledgement) from the remote server; and i) present the confirmation data to the driver and/or store the confirmation data as user account data.

### Exemplary Vehicle

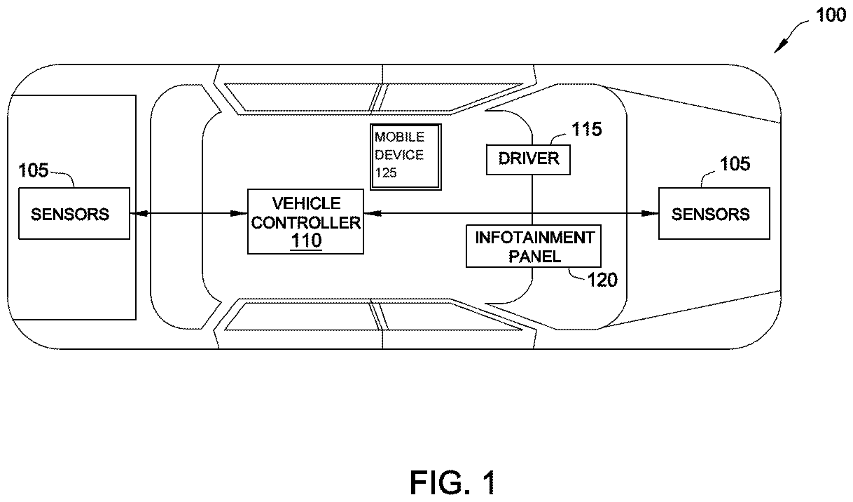

FIG. 1 depicts a schematic view of an exemplary embodiment of a vehicle, for example, a vehicle 100. In some embodiments, vehicle 100 may be an autonomous or semi-autonomous vehicle capable of fulfilling the transportation capabilities of a traditional automobile or other vehicle. In these embodiments, vehicle 100 may be capable of sensing its environment and navigating without human input. In other embodiments, vehicle 100 is a manual vehicle or a semi-autonomous vehicle with driver assistance systems, such as, but not limited to, lane keep assistance and parallel parking assistance, where the vehicle may be a traditional automobile that is controlled by a driver 115.

In the exemplary embodiment, vehicle 100 includes a plurality of sensors 105 and a first controller 110. In the exemplary embodiment, the first controller 110 is a vehicle controller integrated within vehicle 100. In alternative embodiments, first controller 110 is included in a device or devices positioned within or on vehicle 100. The plurality of sensors 105 may detect the current surroundings and location of vehicle 100. In some embodiments, the plurality of sensors 105 are included in a device or devices positioned within or on vehicle 100. In other embodiments, the plurality of sensors 105 are integrated within vehicle 100. In the exemplary embodiment, the plurality of sensors 105 includes at least one roadway observing sensor and a Global Positioning System (GPS) sensor/receiver. The roadway observing sensor is configured to obtain data corresponding to a roadway on which vehicle 100 is traveling and/or areas surrounding the roadway. The GPS sensor is configured to receive location data corresponding to the current location of vehicle 100.

Moreover, the plurality of sensors 105 may include, but is not limited to, radar, LIDAR, proximity sensors, ultrasonic sensors, electromagnetic sensors, wide RADAR, long distance RADAR, GPS sensor/receiver, video devices, imaging devices, cameras, audio recorders, an inertial measurement unit, and computer vision. Sensors 105 may also include sensors that detect conditions of vehicle 100, such as speed, acceleration, gear, braking, and other conditions related to the operation of vehicle 100, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, sensors 105 may include impact sensors that detect impacts to vehicle 100, including force and direction and sensors that detect actions of vehicle 100, such the deployment of airbags.

Vehicle controller 110 may interpret data from sensors 105 to identify appropriate navigation paths, detect threats, and react to conditions. In some embodiments, vehicle controller 110 may be able to communicate with the driver 115 and/or others in the vehicle 100 through an input/output device, for example, an infotainment panel 120 and/or one or more portable computer devices, such as a mobile device 125. For example, the infotainment panel 120 may include a display device that visually outputs information. The infotainment panel 120 may also be in communication with a vehicle stereo system and/or a speaker. In this manner, the infotainment panel 120 may present information aurally. In the example embodiment, mobile device 125 is associated with driver 115 and includes one or more internal sensors, such as an accelerometer, a gyroscope, and/or a compass. Mobile device 125 may include, but is not limited to, a smartphone. Mobile device 125 may be capable of communicating with vehicle controller 110 wirelessly. In addition, vehicle controller 110 and mobile device 125 may be configured to communicate with computer devices located remotely from vehicle 100. In the exemplary embodiment, infotainment panel 120 and mobile device 125 are also input devices that allow a user to provide information/selections to vehicle controller 110, including but not limited to, account data, process settings/preferences, verification or acknowledgement of a detected roadway issue, and/or additional information.

While vehicle 100 may be an automobile in the exemplary embodiment, in other embodiments, vehicle 100 may be, but is not limited to, other types of ground craft and aircraft vehicles.

### Exemplary Process

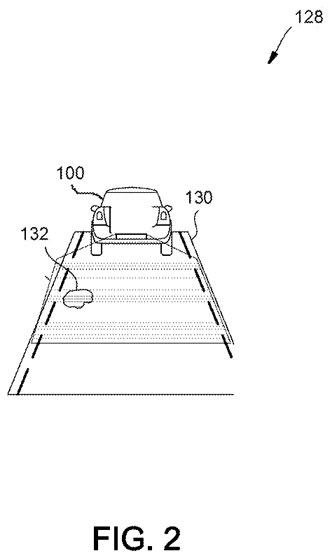

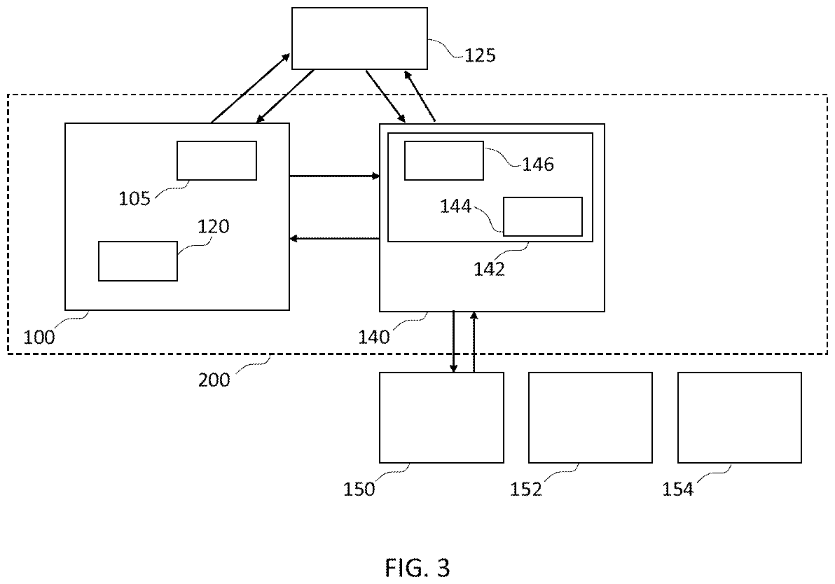

FIG. 2 is an overview diagram 128 illustrating an exemplary application of a roadway issue detecting and reporting system 200 (shown in FIG. 3). In the exemplary embodiment, a vehicle, for example, vehicle 100 (also shown in FIG. 1) is driving on a roadway 130. Within roadway 130 is a roadway issue 132, for example, a pothole. Although illustrated as a pothole, roadway issue 132 may include any hazard, for example, but not limited to, a pothole, debris in the roadway and/or near the roadway, a damaged and/or illegible street sign, an unlit streetlight, a downed power line, a disabled vehicle, and/or a damaged roadway barrier. The roadway issue detecting system 200 is configured to automatically identify and report roadway issue 132 (i.e., identify and report the roadway issue 132 without assistance from driver 115 or any other occupant of vehicle 100). In at least some embodiments, the roadway issue detecting system 200 performs image recognition and machine learning to detect and classify the roadway issue 132 in video recordings and/or other types of data collected by sensors 105 (shown in FIG. 1). In an exemplary embodiment, vehicle controller 110 detects the roadway issue 132, generates classification data that defines what type of roadway issue was detected (e.g., temporary hazard, pothole, debris in the roadway, downed powerline etc.), and transmits roadway issue data that includes the roadway issue classification data and the GPS location data associated with the roadway issue. Vehicle controller 110 may optionally present the driver with a selection that allows the driver to manually confirm/verify the type of roadway issue (i.e., verify that the classification data is accurate), before vehicle controller transmits the roadway issue data.

FIG. 3 is a block diagram of an exemplary embodiment of the roadway issue detecting and reporting system 200. In the exemplary embodiment, roadway issue detecting and reporting system 200 includes a vehicle, for example, vehicle 100 (shown in FIGS. 1 and 2) and a remote server 140. Vehicle 100 includes sensors 105 and infotainment panel 120 (also shown in FIG. 1). The roadway issue detecting and reporting system 200 automatically detects roadway issues, for example, roadway issue 132 (shown in FIG. 2) and provides information to a roadway related entity responsible for care and maintenance of that roadway at that location. Optionally, the roadway issue detecting and reporting system 200 may provide the driver with a selection that allows the driver to manually confirm/verify at least the type of roadway issue. For example, the system 200 may display a message stating that a first type of roadway issue has been detected, the system 200 is ready to report that issue, and request that the driver confirm that the system 200 accurately identified that issue by providing a predefined input. The system 200 may include a timer, for example, a count-down timer, and state that if the driver does not provide an input in a predefined length of time, the system 200 will transmit the roadway issue data. In alternative embodiments, the system 200 may include a timer and state that if the driver does not provide an input in a predefined length of time, the system 200 will not transmit the roadway issue data. The selection between these “opt in” or “opt out” type determinations can be selected by the driver is a settings menu of the system 200.

In the exemplary embodiment, remote server 140 includes, or is communicatively coupled to, a memory 142. Memory 142 stores a roadway entity database 144 and user account data 146. Remote server 140 is configured to determine which of multiple roadway related entities, for example a first roadway related entity 150, a second roadway related entity 152, and a third roadway related entity 154, is responsible for repairing a roadway issue based on information stored in database 144 and the location of the detected roadway issue 132. In the exemplary embodiment, the database 144 includes information associated with each of the multiple roadway related entities, the information including (1) types of roadway issues (e.g., roadway issue classification) the roadway related entity is responsible for addressing, (2) the roadways, and specific locations along the roadways, that the roadway related entity is responsible for maintaining, and (3) contact information for the roadway related entity. The contact information may include any information needed such that the remote server 140 is able to transmit a repair request to the roadway related entity. For example, transmitting the repair request to the proper roadway related entity may include, but is not limited to, transmitting an automatically generated email message to the proper roadway related entity, transmitting an automatically generated voicemail message to the proper roadway related entity, and transmitting an automatically generated SMS text message to the proper roadway related entity.

In one specific example, provided for illustrative purposes only, a vehicle detects a downed powerline near a first location along Highway A, and transmits roadway issue data to remote server 140 including classification data identifying the issue as a downed powerline and GPS location data corresponding to the first location along Highway A. Remote server 140 determines that first roadway related entity 150 (e.g., a local electric power company) is responsible for addressing downed powerlines at the first location along Highway A. In contrast, if a vehicle detects a pothole at the first location along Highway A, and transmits roadway issue data to remote server 140 including classification data identifying the issue as a pothole and GPS location data corresponding to the first location along Highway A, the remote server 140 may determine that second roadway related entity 152 (e.g., a road maintenance department of the municipality in which the first location is located) is responsible for addressing the pothole.

The roadway issue detecting and reporting system 200 also provides confirmation information from the roadway related entity to the driver/owner of the vehicle that detected and reported the roadway issue. In the exemplary embodiment, confirmation information includes, but is not limited to, rewards and/or declarations of appreciation from the roadway related entity. For example, an owner of vehicle 100 may register to participate in a roadway issue detecting and reporting service, and a user account associated with the owner is stored as user account data 146. Driver 115 may input user identification data into an input/output device, for example, infotainment panel 120 and/or mobile device 125 (shown in FIG. 1). The user identification data may include a username and password. Alternatively, user identification data may be automatically obtained by vehicle 100, for example, by communicating with the user's smartphone or a key fob assigned to the user, and/or from a camera or a biometric sensor. The user identification data is transmitted to the remote server 140 and compared to user account data 146 to identify the driver and/or owner of the vehicle as enrolled in the roadway issue reporting service.

In the exemplary embodiment, the remote server 140 may store the confirmation information earned as part of this program in the user account data 146, which may be accessed by the user, for example, using mobile device 125. Alternatively, or in combination, the remote server 140 may transmit the confirmation information to vehicle 100, and, when it is safe (e.g., when vehicle 100 is stopped and/or in PARK), vehicle 100 can present the confirmation information to the driver 115, for example, via infotainment panel 120. Such rewards/declarations may provide the recipient with a sense of engagement or ownership over the roadways upon which they are driving.

### Exemplary Process Timing

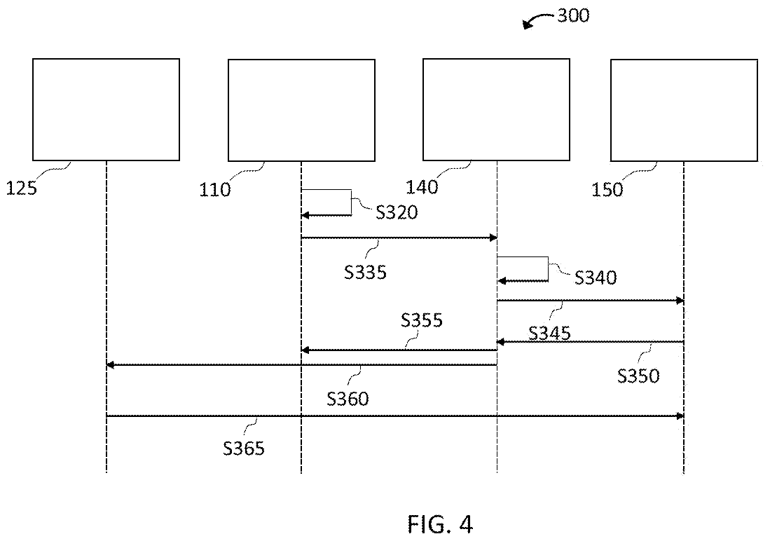

FIG. 4 is a timing diagram for an exemplary embodiment of a process 300 of detecting and reporting roadway issues, for example, using roadway issue detecting and reporting system 200 (shown in FIG. 3). In process 300, a vehicle, for example, vehicle 100 (shown in FIGS. 1 and 2), a remote server, for example, remote server 140 (shown in FIG. 3), a roadway related entity, for example, roadway related entity 150 (shown in FIG. 3), and a user computing device, for example, mobile device 125 (shown in FIG. 3) are communicatively coupled to transmit and receive data as described below.

In step S320, the vehicle controller 110 detects a roadway issue, for example, roadway issue 132 (shown in FIG. 2) and the GPS location of the roadway issue 132. In at least some embodiments, the vehicle controller 110 receives information from one or more sensors 105 and detects roadway issue 132 by analyzing the data received from sensors 105. In an alternative embodiment, vehicle controller 110 transmits the data received from sensors 105 to remote server 140, and remote server 140 detects roadway issue 132 by analyzing the data received from sensors 105.

In step S335, the vehicle controller 110 transmits data corresponding to the roadway issue 132 to remote server 140. For example, the data transmitted includes at least data corresponding to the type of roadway issue identified and GPS location data corresponding to the location of the roadway issue 132. In some alternative embodiments, vehicle controller 110 may optionally present the driver with a selection that allows the driver to manually confirm/verify the type of roadway issue (i.e., verify that the classification data is accurate), before vehicle controller 110 transmits the roadway issue data. In step S340, the remote server 140 accesses database 144 (shown in FIG. 3) to determine the proper roadway related entity, for example, first roadway related entity 150 (shown in FIG. 3) to contact, based at least partially on the roadway issue data (e.g., issue classification data and GPS location data).

In step S345, the remote server 140 transmits the roadway issue data to the proper roadway related entity 150. The roadway related entity 150 may be a government municipality, a private company, and/or any other organization assigned the responsibility for upkeep and maintenance of a roadway and surrounding areas. Based on the roadway issue data, the roadway related entity 150 is notified of the type of roadway issue detected as well as the GPS location of that roadway issue.

In step S350, the roadway related entity 150 transmits a confirmation message to remote server 140. In step S355, the remote server 140 transmits the confirmation message to vehicle controller 110. After receiving the confirmation message, vehicle controller 110 may provide the confirmation message to the infotainment panel 120 and/or mobile device 125 for display to the driver. Alternatively, or in combination, the roadway related entity 150 may transmit the confirmation message directly to vehicle controller 110 and/or mobile device 125. The confirmation message may include data corresponding to a message confirming receipt of the roadway issue data, a message including information identifying the roadway related entity in receipt of the roadway issue data, a message including a statement of appreciation for reporting the roadway issue, a message indicating a repair schedule, a repair status, and/or completion of a repair corresponding to the roadway issue, and/or any other data that allows roadway issue detecting and reporting system 200 to function as described herein. Furthermore, the confirmation data may include an indication of a reward presented to the user as an incentive for the user's vehicle reporting the roadway issue. Moreover, the reward may include a proprietary token, a benefit, a discount, an improved rating either sharable among predefined friends or publicly, and/or any other type of acknowledgement/incentive designed to reward the user for their vehicle's assistance in identifying roadway issue 132.

As a further alternative, the user may register and/or create an account stored by remote server 140 that tracks usage of the roadway issue reporting system 200, and stores data related to the user as account data 146 (shown in FIG. 3). The remote server 140 may store the confirmation message in memory 142 (shown in FIG. 3), for example, as an update to account data 146. The user, through use of a computing device, for example, mobile device 125 (shown in FIG. 3), may transmit a request to access account data 146. For example, mobile device 125 may allow the user to enter a username and password, predefined to authenticate the user, to remote server 140. Upon receipt of the request to access account data 146, and upon authentication of the user, at step S360 remote server 140 transmits the confirmation message to the mobile device 125.

In at least some embodiments, the vehicle controller 110 and/or mobile device 125 is further configured, based on data provided within the confirmation message, to present a rating selection to the user, wherein the rating selection allows the driver to provide feedback corresponding to the roadway related entity. In step S365, the vehicle controller 110 and/or mobile device 125 transmits data corresponding to the rating selection entered by the user to at least one of the remote server 140 and the roadway related entity 150.

### Exemplary Computer Process

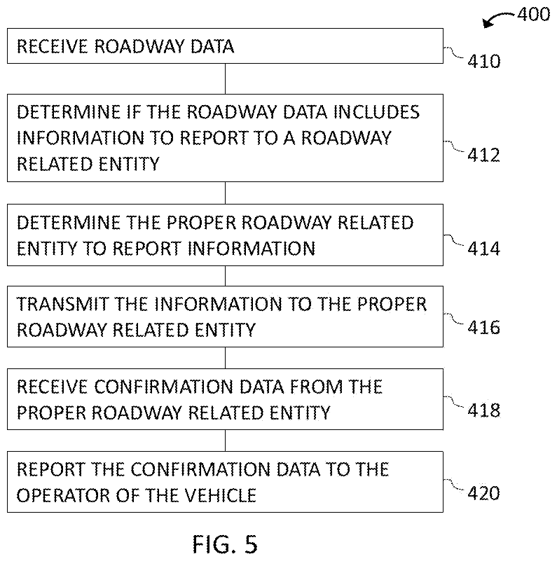

FIG. 5 is a flow chart of an exemplary computer-implemented process 400 of detecting and reporting roadway issues, for example, using the roadway issue detecting and reporting system 200 (shown in FIG. 3).

In the exemplary embodiment, process 400 includes receiving 410 roadway data. Process 400 also includes determining 412 if the roadway data includes information to report to a roadway related entity. For example, vehicle controller 110 may receive 410 roadway data from sensors 105 and may determine 412, based on that roadway data, that a roadway issue is located nearby vehicle 100. Furthermore, vehicle controller 110 may determine 412, based on information from sensors 105, the GPS location of the detected roadway issue.

Process 400 further includes determining 414 the proper roadway related entity assigned to repair or otherwise take care of a specific type of roadway issue at that GPS location, and transmitting 416 the roadway issue data to the proper roadway related entity. In at least some embodiments, the remote server 140 determines 414 the proper roadway related entity to send a repair request and then transmits 416 the roadway issue data to that entity. Transmitting 416 the roadway issue data may include transmitting a repair request to the proper roadway related entity. That may include, for example, at least one of transmitting an automatically generated email message to the proper roadway related entity, transmitting an automatically generated voicemail message to the proper roadway related entity, and transmitting an automatically generated SMS text message to the proper roadway related entity.

Process 400 also includes receiving 418 a confirmation from the proper roadway related entity. For example, at least one of the remote server 140, the vehicle controller 110, and mobile computer 125 receives 418 the confirmation. The confirmation may include data corresponding to a message confirming receipt of the roadway issue data, a message including information identifying the roadway related entity in receipt of the roadway issue data, a message including a statement of appreciation for reporting the roadway issue, and/or a message indicating a repair schedule, a repair status, and/or completion of a repair corresponding to the roadway issue.

Process 400 further includes reporting 420 the confirmation to the operator of the vehicle and/or the owner of the vehicle. Reporting 420 may include outputting, via a display device, a visual representation of the confirmation data. Reporting 420 may include outputting, via an audio device, an auditory representation of the confirmation data. Moreover, confirmation information may be displayed using mobile device 125, infotainment panel 120, and/or any other display/device that allows this invention to function as described herein.

### Exemplary Computer System

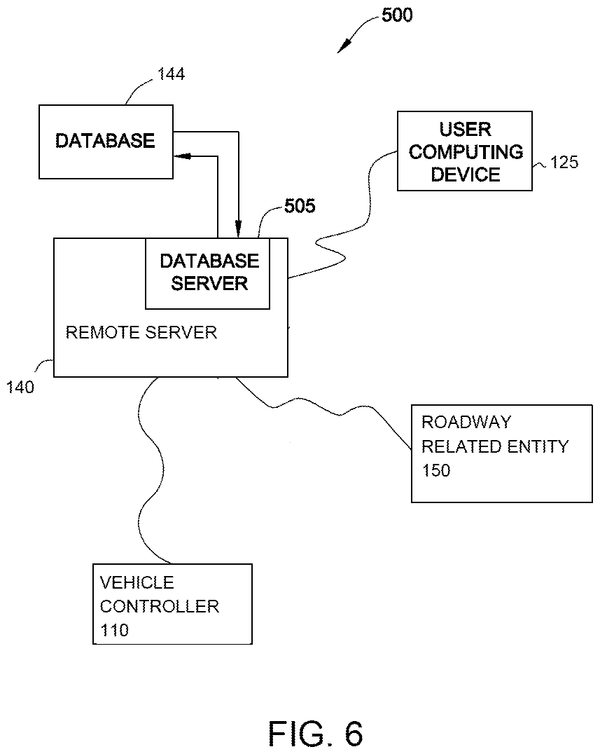

FIG. 6 illustrates a simplified block diagram of an exemplary computer system 500 for implementing roadway issue detecting and reporting system 200 (shown in FIG. 3) and the processes 300 and 400 (shown in FIGS. 4 and 5). In the exemplary embodiment, computer system 500 may be used for detecting roadway issue 132 and for reporting the existence and location of the roadway issue 132 to the proper authority. As described herein in more detail, the remote server 140 may be configured to (i) receive roadway issue classification data and GPS location data corresponding to a detected roadway issue from the vehicle controller 110; (ii) determine the proper roadway related entity, for example, roadway related entity 150; (iii) transmit a repair request to the proper roadway related entity 150; (iv) receive confirmation data from the proper roadway related entity 150; and (v) store the confirmation data as user account data 146. In an exemplary embodiment, vehicle controller 110, remote server 140, roadway related entity 150, and mobile computing device 125 are in communication using the Internet or other network. More specifically, vehicle controller 110, remote server 140, roadway related entity 150, and mobile computing device 125 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Moreover, computer communication can utilize any type of wired, wireless, or network communication protocol including, but not limited to, Ethernet (e.g., IEEE 802.3), Wi-Fi (e.g., IEEE 802.11), communications access for land mobiles (CALM), WiMAX, Bluetooth, Zigbee, ultra-wideband (UWB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

A database server 505 may be communicatively coupled to a database, for example, database 144 (shown in FIG. 3), that stores data. In one embodiment, database 144 includes contact information for the roadway related entities responsible for maintenance of roadways, wherein which entity is the proper entity to contact is determined based on which roadway, and the GPS location along that roadway, where a roadway issue is identified. In the exemplary embodiment, database 144 may be stored remotely from remote server 140. In some embodiments, database 144 may be decentralized.

In the exemplary embodiment, user computer devices 125 are computers that include a web browser or a software application, which enables user computer devices 125 to access remote computer devices, such as remote server 140, using the Internet or other network. More specifically, user computer devices 125 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 125 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

### Exemplary Client Device

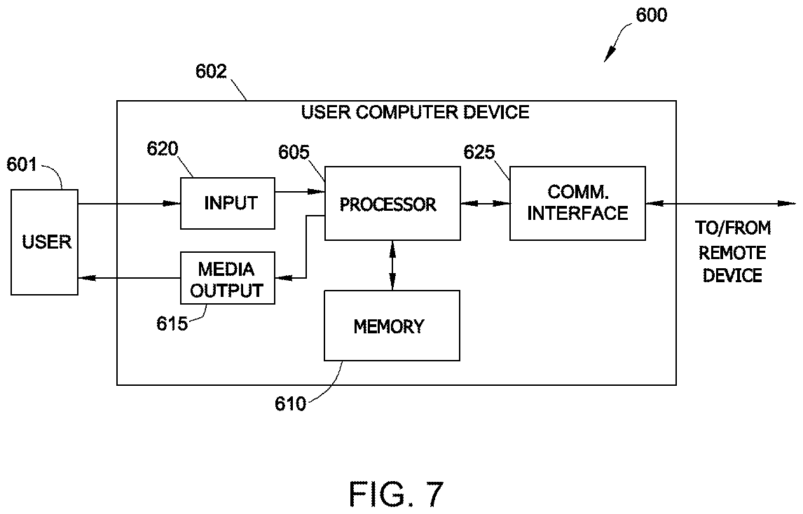

FIG. 7 depicts an exemplary configuration 600 of user computer device 602, in accordance with one embodiment of the present disclosure. In the exemplary embodiment, user computer device 602 may be similar to, or the same as, and user computer device 125 (shown in FIG. 6). User computer device 602 may be operated by a user 601. User computer device 602 may include, but is not limited to, vehicle controller 110 (shown in FIG. 1), infotainment panel 120 (shown in FIG. 1), and user computer device 125. User computer device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or repair data to be stored and retrieved. Memory area 610 may include one or more computer readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively coupleable to an output device such as a display device (e.g., a liquid crystal display (LCD), light emitting diode (LED) display, or “electronic ink” display) or an audio output device (e.g., a speaker or headphones).

In some embodiments, media output component 615 may be configured to present a graphical user interface (e.g., a web browser and/or a client application) to user 601. A graphical user interface may include, for example, an interface for viewing a confirmation message. In some embodiments, user computer device 602 may include an input device 620 for receiving input from user 601. User 601 may use input device 620 to, without limitation, enter user account information and provide roadway related entity rating information.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as remote server 140. Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from remote server 140. A client application may allow user 601 to interact with, for example, remote server 140. For example, instructions may be stored by a cloud service, and the output of the execution of the instructions sent to the media output component 615.

In some embodiments, user computer device 602 may include, or be in communication with, one or more sensors, such as sensors 105 (shown in FIG. 1). User computer device 602 may be configured to receive data from the one or more sensors and store the received data in memory area 610. Furthermore, user computer device 602 may be configured to transmit the sensor data to a remote computer device, such as vehicle controller 110, mobile device 125, or remote server 140, through communication interface 625.

In the exemplary embodiment, the vehicle 100 includes plurality of sensors 105 (shown in FIG. 1) and vehicle controller 110. The vehicle controller includes at least one processor 605 in communication with at least one memory device 610. The vehicle controller 110 collects a plurality of sensor information observed by the plurality of sensors 105 during operation of the vehicle 100. The vehicle controller 110 analyzes the plurality of sensor information to detect a roadway issue 132 (shown in FIG. 2). The vehicle controller 110 transmits data corresponding to the roadway issue 132 as well as the GPS location of the roadway issue 132 to the remote server 140.

### Exemplary Server Device

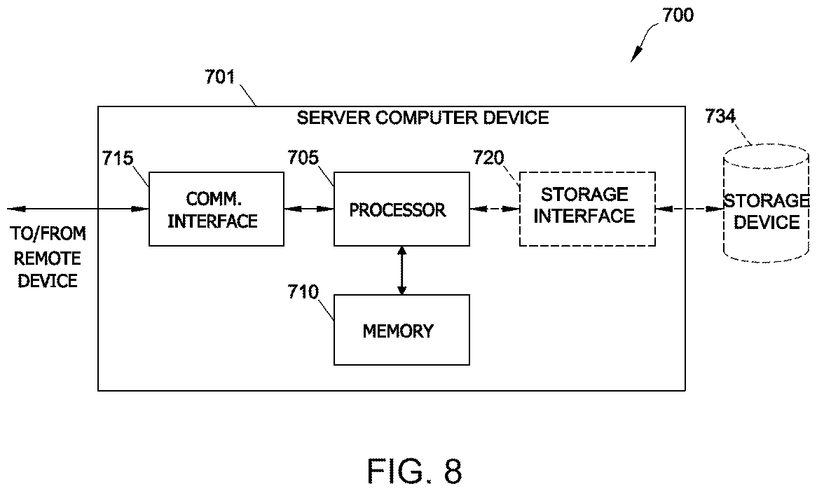

FIG. 8 depicts an exemplary configuration 700 of a server computer device 701, in accordance with one embodiment of the present disclosure. In the exemplary embodiment, server computer device 701 may be similar to, or the same as, remote server 140 (shown in FIG. 2) and/or database server 505 (shown in FIG. 6). Server computer device 701 may include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 is capable of communicating with a remote device such as another server computer device 701, remote server 140, vehicle controller 110, (both shown in FIG. 3), roadway related entity 150, and/or user computer devices 125 (both shown in FIG. 6) (for example, using wireless communication or data transmission over one or more radio links or digital communication channels). For example, communication interface 715 may receive requests from user computer devices 125 via the Internet, as illustrated in FIG. 6.

Processor 705 may also be operatively coupled to a storage device 734. Storage device 734 may be any computer-operated hardware suitable for storing and/or retrieving data, such as, but not limited to, data associated with database 144 (shown in FIG. 6). In some embodiments, storage device 734 may be integrated in server computer device 701. For example, server computer device 701 may include one or more hard disk drives as storage device 734.

In other embodiments, storage device 734 may be external to server computer device 701 and may be accessed by a plurality of server computer devices 701. For example, storage device 734 may include a storage area network (SAN), a network attached storage (NAS) system, and/or multiple storage units such as hard disks and/or solid-state disks in a redundant array of inexpensive disks (RAID) configuration.

In some embodiments, processor 705 may be operatively coupled to storage device 734 via a storage interface 720. Storage interface 720 may be any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instruction such as illustrated in FIGS. 2-5.

### Exemplary User Interface

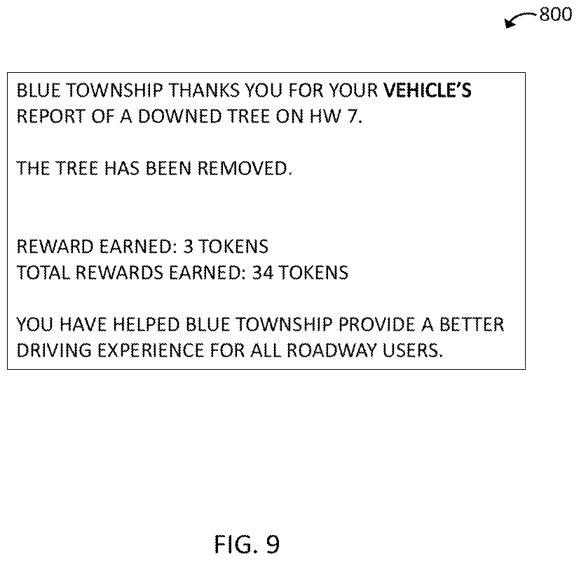

FIG. 9 is a screenshot of one example of a user interface 800 displaying the content of a confirmation message transmitted from at least one of a roadway related entity, for example, roadway related entity 150 (shown in FIG. 3) and a remote server, for example, remote server 140 (shown in FIG. 3). In the exemplary embodiment, the user interface 800 may be displayed on mobile device 125, on a display of infotainment panel 120 (shown in FIG. 1), and on any other display device. The message displayed on the user interface may include acknowledgement of receipt of the roadway issue data, a statement of appreciation, a description of actions taken by the roadway related entity in response to receipt of the roadway issue data, a description of an award earned by the user for reporting the roadway issue, and/or a description of a total number of awards earned by the user.

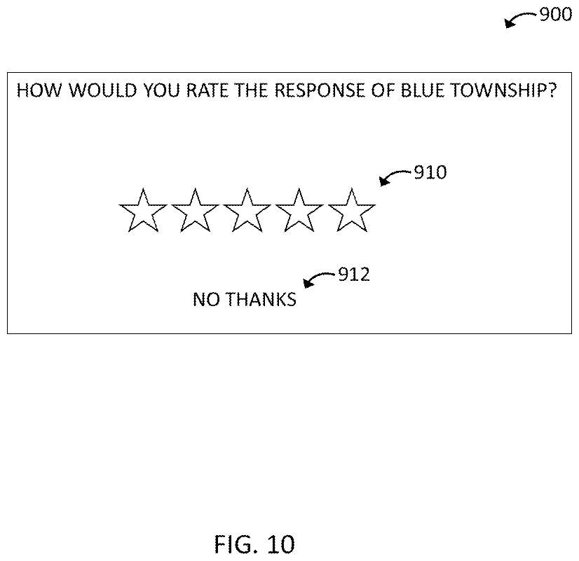

FIG. 10 is a screenshot of another example of a user interface 900 displaying additional content of a confirmation message transmitted from the roadway related entity and/or remote server and presented to the user. User interface 900 includes a rating selection 910, presented to the user. In the illustrated example, the rating selection 910 is a plurality of stars, wherein selecting all five stars corresponds to a high ranking, and wherein selecting a lower number of stars corresponds to lower rankings. The rating selection allows the user to provide feedback corresponding to the roadway related entity that provided the confirmation message. For example, after the user enters the rating selection using, for example, the infotainment panel 120 and/or mobile device 125, the vehicle controller 110 and/or mobile device 125 transmits the rating selection entered by the user to at least one of the remote server 140 and the roadway related entity 150. In the exemplary embodiment, user interface 900 is displayed by the infotainment panel 120 (shown in FIG. 1) and/or mobile device 125. In the exemplary embodiment, user interface 900 also provides a no-response option 912 should the user prefer not to provide a rating for the roadway related entity 150.

### Machine Learning & Other Matters

The computer systems and computer-implemented methods discussed herein may include additional, less, or alternate actions and/or functionalities, including those discussed elsewhere herein. The computer systems may include or be implemented via computer-executable instructions stored on non-transitory computer-readable media. The methods may be implemented via one or more local or remote processors, transceivers, servers, and/or sensors (such as processors, transceivers, servers, and/or sensors mounted on mobile computing devices, or associated with smart infrastructure or remote servers), and/or via computer executable instructions stored on non-transitory computer-readable media or medium.

In some embodiments, a roadway issue detecting support platform computing device is configured to implement machine learning, such that the roadway issue detecting computing device “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to: user data, sensor data, assignment data, calendar data, task data, recording data, location data, and/or alert data. ML outputs may include but are not limited to: user data, classification data, calendar data, task data, identification data, location data, and/or assignment data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. For example, a ML module may receive training data comprising image data, sensor data, and location data, and assignment data associated with roadway issue data. The ML module may then generate a model which maps image data to aspects of the roadway issue data. The ML module may then generate assignment data as a ML output based upon subsequently received image data and location data.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above. For example, a ML module may receive unlabeled data comprising image data, sensor data, and location data. The ML module may employ an unsupervised learning method such as “clustering” to identify patterns and organize the unlabeled data into meaningful groups. The newly organized data may be used, for example, to generate a model which associates image data and location data.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

### Additional Considerations

In the above specification and the subsequent claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., roadway issue location information, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

Exemplary embodiments of systems and methods for detecting and reporting roadway issues, and providing incentives for participating in the program, are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A roadway issue detecting and reporting system comprising:
a plurality of sensors including a global positioning system (GPS) sensor and a roadway observing sensor; and
a first controller communicatively coupled to the plurality of sensors, wherein the first controller is programmed to:
receive roadway data and GPS location data from the plurality of sensors;
detect a roadway issue based on the roadway data and a corresponding location based on the GPS location data;
generate roadway issue data including roadway issue classification data and the GPS location data associated with the roadway issue;
transmit the roadway issue data to a remote server;
receive confirmation data from the remote server; and
present the confirmation data to a user.

2. A system in accordance with claim 1, wherein the first controller is further programmed to receive user identification data.

3. A system in accordance with claim 2, wherein receive user identification data includes receiving data, via at least one of an input device of a vehicle and a smartphone communicatively coupled to the vehicle, identifying a driver and/or owner of the vehicle.

4. A system in accordance with claim 3, wherein receiving data identifying the driver and/or owner of the vehicle comprises receiving a username and password associated with the driver and/or owner of the vehicle, wherein the username and password are configured to prove enrollment in a roadway issue reporting service.

5. A system in accordance with claim 1, wherein the first controller comprises a vehicle controller included within a vehicle.

6. A system in accordance with claim 1, wherein the roadway observing sensor includes at least one of a camera, a radar, and a LIDAR.

7. A system in accordance with claim 1, wherein detect a roadway issue comprises analyzing the roadway data to detect roadway issues identifiable within the roadway data.

8. A system in accordance with claim 1, wherein the roadway issue classification data defines a type of roadway issue detected, and wherein the type of roadway issue includes at least one of a stationary hazard, a temporary hazards, a pothole, debris in the roadway, a damaged and/or illegible street sign, an unlit streetlight, a downed power line, and a damaged roadway barrier.

9. A system in accordance with claim 1, further comprising a display device communicatively coupled to the first controller, wherein the display device comprises at least one of a display screen and an audio output device, and wherein present the confirmation data to the user includes outputting, via the display device, a visual and/or auditory representation of the confirmation data.

10. A system in accordance with claim 1, wherein the confirmation data includes at least one of a message confirming receipt of the roadway issue data, a message including information identifying a roadway related entity in receipt of the roadway issue data, a message including a statement of appreciation for reporting the roadway issue, and a message indicating a repair schedule, a repair status, and completion of a repair corresponding to the roadway issue.

11. A system in accordance with claim 1, wherein the confirmation data includes an indication of a reward presented to the user as an incentive for the vehicle reporting the roadway issue.

12. A system in accordance with claim 11, wherein the reward is at least one of a proprietary token, benefits, discounts, and an improved rating either sharable among predefined friends or publicly.

13. A system in accordance with claim 1, wherein the vehicle controller is further programmed to present a rating selection to the user, wherein the rating selection allows the user to provide feedback corresponding to the roadway related entity.

14. A vehicle comprising:
a plurality of sensors including a global positioning system (GPS) sensor and a roadway observing sensor;
an input/output device; and
a first vehicle controller communicatively coupled to the plurality of sensors and the input/output device, wherein the first vehicle controller is configured to:
receive roadway data and GPS location data from the plurality of sensors;
detect a roadway issue based on the roadway data and a corresponding location based on the GPS location data;
generate roadway issue data including roadway issue classification data and the GPS location data associated with the roadway issue;
transmit the roadway issue data to a remote server;
receive confirmation data from the remote server; and
transmit the confirmation data to the input/output device.

15. A roadway issue reporting system comprising:
at least one memory device; and
a server communicatively coupled to the at least one memory device and comprising at least one processor, wherein the server is configured to:
receive roadway issue data from a vehicle, wherein the roadway issue data includes roadway issue classification data and GPS location data corresponding to a location of the roadway issue;
determine a proper roadway related entity to contact;
transmit a repair request to the proper roadway related entity;
receive confirmation data from the proper roadway related entity; and
store the confirmation data as user account data.

16. A roadway issue reporting system in accordance with claim 15, wherein determine a proper roadway related entity to contact includes:
determining a roadway corresponding to the GPS location data of the roadway issue; and
accessing a database, stored in the at least one memory, that includes roadway related entity data.

17. A roadway issue reporting system in accordance with claim 16, wherein the roadway related entity data includes:
types of roadway issues the roadway related entity is responsible for addressing;
the roadways, and specific locations along the roadways, that the roadway related entity is responsible for maintaining; and
contact information for the roadway related entity.

18. A roadway issue reporting system in accordance with claim 15, wherein transmit a repair request to the proper roadway related entity includes transmitting the roadway issue data corresponding to the roadway issue and GPS location to the proper roadway related entity.

19. A roadway issue reporting system in accordance with claim 15, wherein store the confirmation data as user account data includes storing at least one of a message confirming receipt of the data corresponding to the roadway issue, a message including information identifying a roadway related entity in receipt of the data corresponding to the roadway issue, a message including a statement of appreciation for reporting the roadway issue, and a message indicating a status of a repair corresponding to the roadway issue.

20. A roadway issue reporting system in accordance with claim 15, wherein the confirmation data includes at least one of:
an indication of a reward presented to the user as an incentive for the user's vehicle reporting the roadway issue; and
a rating selection to be presented to the user, wherein the rating selection allows the user to provide feedback corresponding to the roadway related entity.
